(19) United States
(12) Patent Application Publication
(10) Pub. No.: US 2010/0237798 A1
(43) Pub. Date: Sep. 23, 2010

(54) Method and apparatus for retrofitting lighting fixtures with dimmable color selectable light emitting diodes

(76) Inventors: Jeffrey Brian Wolf, Carlsbad, CA (US); Jason Vogel, Simi Valley, CA (US)

Correspondence Address: Kirk Hermann, 150 Cerro Vista Way, Anaheim, CA, 92807, US

(21) Appl. No.: 12/460,590

(22) Filed: Jul. 21, 2009

Related U.S. Application Data
(63) Continuation-in-part of application No. 12/383,438, filed on Mar. 23, 2009.

(51) Int. Cl. H05B 37/02; H01J 9/24

(52) U.S. Cl. 315/294; 445/23

(57) ABSTRACT

A method and apparatus for retrofitting a lighting fixture with at least one LED and an attachment configured to couple the light retrofitting means to a network including a power line; and a controlling means configured to influence the intensity and color of light emitted by the lighting means.

### CROSS-REFERENCE TO RELATED APPLICATION

This is a continuation-in-part application of currently pending U.S. patent application Ser. No. 12,383,438, entitled “DIMMABLE COLOR SELECTABLE LIGHT EMITTING DIODES” filed on Mar. 23, 2009, the entire contents of which are incorporated herein by reference.

### TECHNICAL FIELD

The present invention relates to a method and apparatus for retrofitting lighting fixtures with light emitting diodes (LEDs), and more particularly, the present invention relates to a method and apparatus for retrofitting lighting fixtures containing incandescent, fluorescent and/or halogen lights with dimmable, color selectable LEDs.

### BACKGROUND

The current trend in lighting is toward more controllable and more energy efficient lighting solutions. In order to satisfy such requirements, light emitting diodes (LEDs) have begun to replace incandescent, fluorescent and halogen lights.

However, there is a desire to have individual LEDs be controlled and synchronized to produce lighting of a certain intensity, warmth and color.

In addition, there is a desire to install and control LEDs through the use of a location's existing wiring without the necessity of major rewiring or having to install additional hardware and/or software.

The above information disclosed in this Background section is only for enhancement of understanding of the background of the invention and therefore it may contain information that does not form the prior art that is already known in this country to a person of ordinary skill in the art.

### SUMMARY OF THE INVENTION

In certain embodiments of the present invention, a method for retrofitting a lighting fixture, the lighting fixture including prior to the retrofitting a housing and a light source located substantially within the housing, the method including the steps of: removing the light source from the housing; and attaching to the housing a retrofit apparatus comprising a first light source including at least one LED and being configured to communicate with a second light source over a network including at least one power line, wherein the first light source is coupled to a controller configured to communicate with the first and second light sources over the network to control the intensity and color of light emitted by the first and second light sources.

In certain embodiments of the present invention, a method for retrofitting a luminaire, the luminaire including a housing including at least one of a diffuser and a lens wherein the at least one of a diffuser and a lens is attached to the housing, and within the housing is at least one incandescent, fluorescent and halogen light, the method including the steps of: substantially removing any of the at least one of a diffuser and a lens; removing from within the housing the at least one incandescent, fluorescent or halogen light source; and mounting to the housing a retrofit apparatus including a direct current (DC) power supply electrically coupled to a first light source including at least one LED, wherein the first light source is configured to communicate with a second light source over a network including at least one power line and the first light source is coupled to a controller configured to communicate with the first and second light sources over the network to control the intensity and color of light emitted by the first and second light sources.

In certain embodiments of the present invention, an apparatus for retrofitting a lighting fixture including: a light retrofitting means including at least one LED and an attachment configured to couple the light retrofitting means to a network including a power line; and a controlling means configured to influence the intensity and color of light emitted by the lighting means.

These and other features, aspects and advantages of the present invention will become better understood with reference to the following drawings, description and claims.

### BRIEF DESCRIPTION OF THE DRAWINGS

FIG. 1 illustrates a dimmable color selectable light emitting diode (LED) lighting system including an apparatus for retrofitting a lighting fixture according to one embodiment of the present invention;

FIG. 2 illustrates a topology of a dimmable color selectable light emitting diode (LED) lighting system including an apparatus for retrofitting a lighting fixture according to one embodiment of the present invention;

FIG. 3 illustrates a cross-sectional view of an apparatus for retrofitting a lighting fixture according to one embodiment of the present invention;

FIGS. 4A through 4F illustrate a method of retrofitting a lighting fixture according to one embodiment of the present invention;

FIGS. 5A through 5E illustrate a method of retrofitting a lighting fixture according to one embodiment of the present invention;

FIG. 6 is a table of various light sources' sizes, LED count, light intensity output, color description, color temperature and power consumption according to certain embodiments of the present invention;

The foregoing will be apparent from the following more, particular description of example embodiments of the present invention, as illustrated in the accompanying drawings. The drawings are not necessarily to scale, emphasis instead being placed upon illustrating embodiments of the present invention.

### DETAILED DESCRIPTION OF THE INVENTION

The following detailed description of example embodiments of the invention is not to be taken in a limiting sense, but is made merely for the purpose of illustrating the general principles of the invention, since the scope of the invention is best defined by the appended claims.

Broadly speaking, the present invention generally provides a retrofit for a lighting fixture wherein the retrofit includes a light source including at least one LED configured to be controlled using a network including at least one power line.

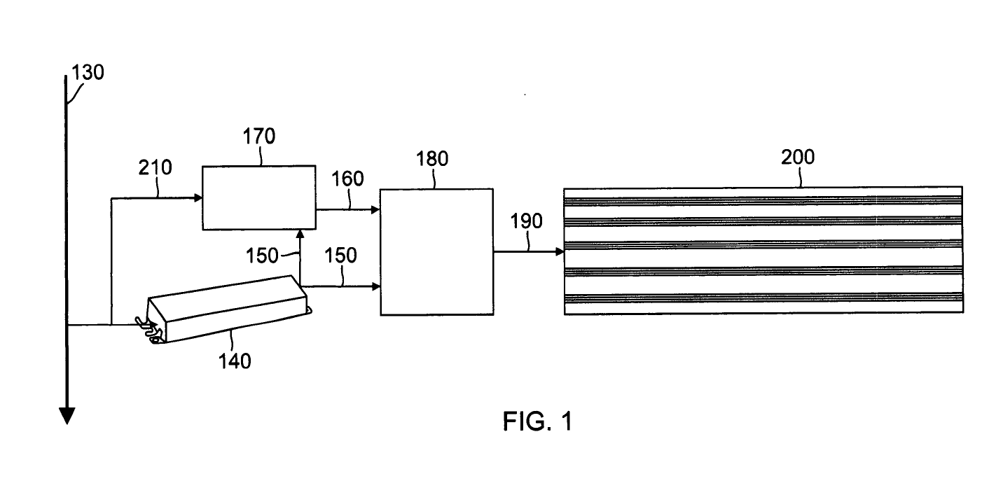

Referring now to the figures, FIG. 1 shows an LED lighting system including an apparatus for retrofitting a lighting fixture according to one embodiment of the present invention. FIG. 1 shows a network including a power line 130, a connection for transmitting color and brightness commands 210 to a processor 170, a red/green/blue (color) controller 180, color and dimming commands sent from the network processor to the red/green/blue (color) controller 160, a light source including LEDs 200, pulse width modulated DC power supplied to the light source 190, a DC power supply 140 receiving power from the network including a power line 130, DC power connection 150 connecting the DC power supply 140 to both the network processor 170 and the red/green/blue (color) controller 180. In certain embodiments of the present invention, the lighting fixture is a free standing lamp/portable lamp or a fixed lamp, including but not limited to a table lamp, a standard lamp, a floor lamp, a balanced arm lamp, a nightlight, a luminaire, a recessed light, a troffer light, a cove light, a chandelier, a pendant light, a sconce, a under-cabinet light, an emergency or exit light, a high bay/low bay light, a strip light, an industrial light, a stanchion, a pathway light, a bollard light. In certain embodiments of the present invention, the network including a power line 130 includes a local area network (LAN), a wide area network (WAN), a wireless network or any other type of network known in the art. In certain embodiments of the present invention, connection for transmitting color and brightness commands 210 is an electrical connection, an optical connection, a magnetic connection, a wireless connection or any other type of connection known in the art. In certain embodiments of the present invention the DC power supply 140 is configured to receive alternating current from at least one power line and to supply 12 or 24 volts to the network processor 170 and the red/green/blue (color) controller 180.

In certain embodiments of the present invention, the apparatus for retrofitting a lighting fixture includes a polycarbonate lens. In certain embodiments of the present invention, the apparatus for retrofitting a lighting fixture includes a polycarbonate lens including a dual-wall polycarbonate material. In certain embodiments of the present invention, the apparatus for retrofitting a lighting fixture includes a detector for detecting at least one of motion and sound.

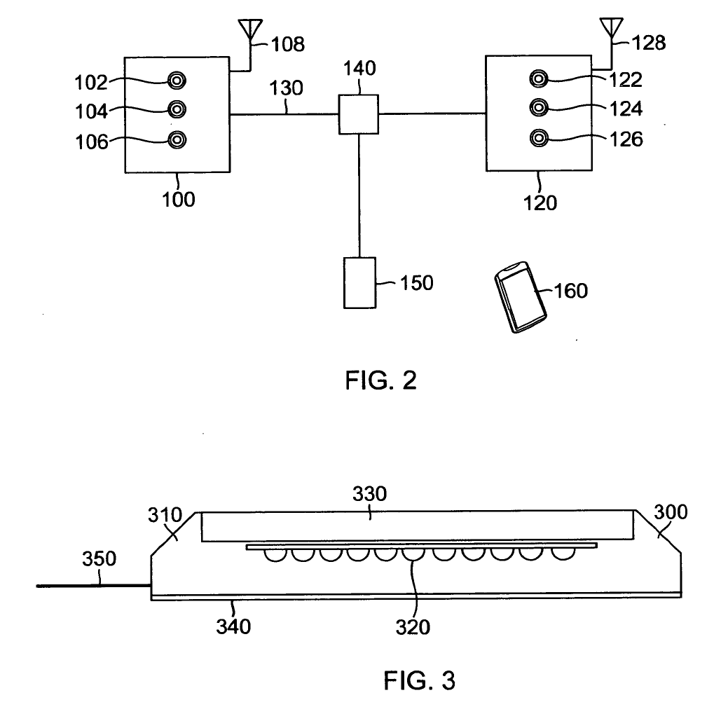

FIG. 2 shows a topology of a dimmable color selectable light emitting diode (LED) lighting system including an apparatus for retrofitting a lighting fixture according to one embodiment of the present invention. FIG. 2 includes light sources 100 and 120 including LEDs 102, 104, 106, 122, 124 and 126, an optional antenna 108 and 128, a network including a power line 130, a controller 140 for adjusting the brightness and color of the light emanating from the LEDs (102, 104, 106, 122, 124 and 126), a switch 150 and a remote controller 160. In certain embodiments the network including a power line 130 is a local area network (LAN), a wide area network (WAN), a wireless network or any other type of network known in the art. In certain embodiments of the present invention the LED lighting system includes a motion or sound detector that can allow for example sequential light sources (100 and 120) to turn-on as a person comes within close proximity.

In certain embodiments of the present invention the color of the individual LEDs (102, 104, 106, 122, 124 and 126) can be, white, red, green, blue or any other color or combination of colors. One well known manufacturer of LEDs is Cree, Inc. of Durham, N.C.

In certain embodiments of the present invention light sources 100 and 120 include a controller 140 for adjusting the brightness and color of the light emanating from the LEDs 102, 104, 106, 122, 124 and 126, and a communication interface to facilitate communication between the light sources (100 and 120) and the controller 140 for adjusting the brightness and color of the light emanating from the LEDs (102, 104, 106, 122, 124 and 126) over a network including at least one power line 130. In certain embodiments of the present invention the light sources (100 and 120) are configured to communicate with one another and with the controller 140 for adjusting the brightness and color of the light emanating from the LEDs (102, 104, 106, 122, 124 and 126) over a network including at least one power line in a fully meshed peer-to-peer relationship repeating signals received to reduce the possibility of any one light source (100 and 120) being out of sync with the others (100 and 120). In certain embodiments of the present invention the light sources (100 and 120) include light sensors to measure the intensity and color of light being produced. In certain embodiments of the present invention each light source (100 and 120) includes a unit address which may include an internet protocol (IP) address. In certain embodiments of the present invention each light source (100 and 120) is configured to be able to send a message to controller 140 for adjusting the brightness and color of the light emanating from the LEDs (102, 104, 106, 122, 124 and 126) such as an alert as to its condition for example when individual LEDs (102, 104, 106, 122, 124 and 126) are nonoperational so the a controller 140 for adjusting the brightness and color of the light emanating from the LEDs (102, 104, 106, 122, 124 and 126) can adjust the level of light emanating from that light source (100 and 120) or other light sources (100 and 120) to compensate for the condition. In certain embodiments of the present invention a controller 140 for adjusting the brightness and color of the light emanating from the LEDs (102, 104, 106, 122, 124 and 126) is either attached to the outside of each of the light sources (100 and 120) via screws or snap-on fittings, or housed within the light sources (100 and 120).

In certain embodiments of the present invention the network including at least one power line 130 operates using ac power-lines based on a protocol such as X-10 standard or universal power line bus (UPB) standard. In certain embodiments of the present invention the network including at least one power line 130 operates based on a dual mesh topology utilizing ac-power lines and a radio-frequency protocol such as the Insteon technology offered by SmartLabs, Inc. of Irvine, Calif.

The controller 140 for adjusting the brightness and color of the light emanating from the LEDs (102, 104, 106, 122, 124 and 126) is configured to communicate over the network including a power line 130 to adjust the brightness of one or more light sources. In certain embodiments of the present invention, since the controller 140 recognizes the unit address of each light source, additional light sources can be added in proximity to existing ones and the controller 140 will be able to communicate to them without the need of additional wiring. In certain embodiments of the present invention, the controller 140 can control the light intensity and/or color emanating from the light sources (100 and 120) from 0% to 100% in configurable steps or nonlinearly such as providing a soft turn-on and turn-off of the intensity and color of the light emanating from the light sources (100 and 120). In certain embodiments of the present invention, the controller 140 can control the light intensity and/or color emanating from the light sources (100 and 120) to provide light therapy (also known as phototherapy). In certain embodiments of the present invention, the controller 140 can control the light intensity and/or color emanating from the light sources (100 and 120) based on the time of day and/or the individual in the room to provide customized light therapy (also known as phototherapy). In certain embodiments of the present invention, individuals can wear a badge containing an RFID tag (passive or active RFID tag) that is in communication with the remote controller 160 and/or switch 150 using either a radio-frequency protocol or an infrared protocol and/or a network including a power line.

In certain embodiments of the invention the controller 140 for adjusting the brightness and color of the light emanating from the LEDs (102, 104, 106, 122, 124 and 126) includes a controller for adjusting the level of brightness of the light emanating from the LEDs (102, 104, 106, 122, 124 and 126) that is separate from the controller for adjusting the color of the light emanating from the LEDs (102, 104, 106, 122, 124 and 126). In certain embodiments of the present invention, invention the controller 140 for adjusting the brightness and color of the light emanating from the LEDs (102, 104, 106, 122, 124 and 126) can operate via pulse modulation to control the amount of energy being consumed by each light source. In certain embodiments of the present invention the light sources (100 and 120) include red, green and blue LEDs and the controller 140 for adjusting the brightness and color of the light emanating from the LEDs (102, 104, 106, 122, 124 and 126) is configured to produce any color in the visible spectrum by pulse modulating the amount of energy to each of the LEDs (102, 104, 106, 122, 124 and 126). In certain embodiments of the present invention, each group of colored LEDS (102, 104, 106, 122, 124 and 126) in the light source (100 and 120) has a separate drive line along with a common return line. In certain embodiments of the present invention coupled to each light source (100 and 120) is an individual controller 140 for controlling the brightness and color of light emanating from the LEDS (102, 104, 106, 122, 124 and 126) in the light source (100 and 120). In certain embodiments of the present invention a controller 140 for adjusting the brightness and color of the light emanating from the LEDs (102, 104, 106, 122, 124 and 126) is either attached directly to each of the light sources 100 and 120 or housed within the light sources (100 and 120).

The switch 150 can be any type of switch known in the art, for example in certain embodiments of the present invention it can include a three-way toggle dimmer switch for adjusting the color and intensity of the light emanating from the LEDs (102, 104, 106, 122, 124 and 126). In certain embodiments of the present invention the switch 150 is configured to communicate with the controller 140 for adjusting the brightness and color of the light emanating from the LEDs (102, 104, 106, 122, 124 and 126) over the network including a power line (130).

In certain embodiments of the present invention the remote controller 160 is configured to communicate with the switch 150 using either a radio-frequency protocol or an infrared protocol and/or a network including a power line. In certain embodiments of the present invention the remote controller 160 displays information from the controller 140 for adjusting the brightness and color of the light emanating from the LEDs (102, 104, 106, 122, 124 and 126) and/or light sources (100 and 120) such as amount of energy consumed or the remaining life of the light sources' LEDs.

FIG. 3 shows a cross-sectional view of a retrofit of a lighting fixture 300 according to certain embodiments of the present invention. FIG. 3 includes a housing 310, a lens 340, an attachment configured to connect to a network including a power line 350, replacement ballast cover (330), and LEDs 320. The lens 340 can consist of any type of material known in the art such as clear dual-wall polycarbonate material that has thermal insulating properties. The attachment configured to connect to a network including a power line 350 can include a power plug, a universal serial bus (USB) connector or any other type of connector known in the art. In certain embodiments of the present invention the retrofit of a lighting fixture 300 can include a built in power supply such as a constant-current power supply.

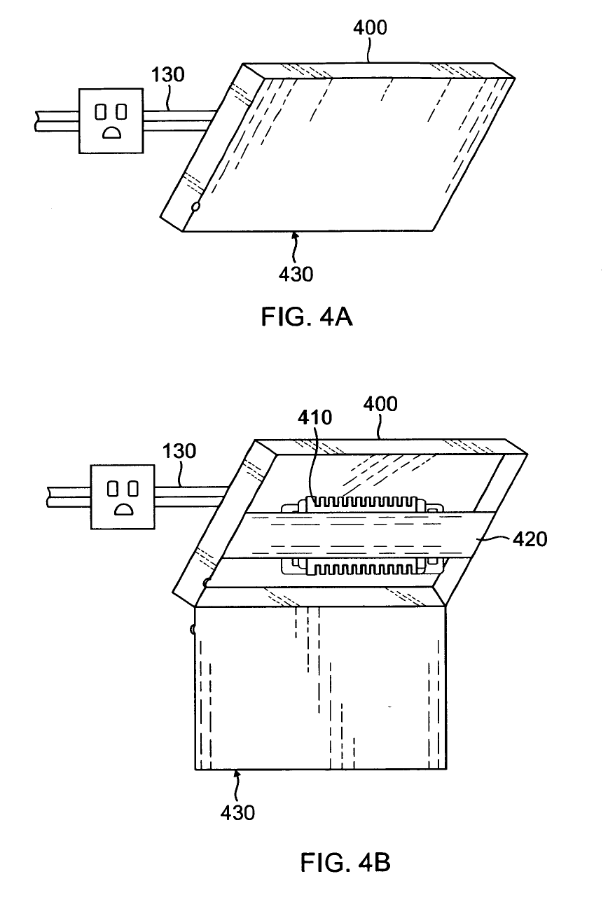

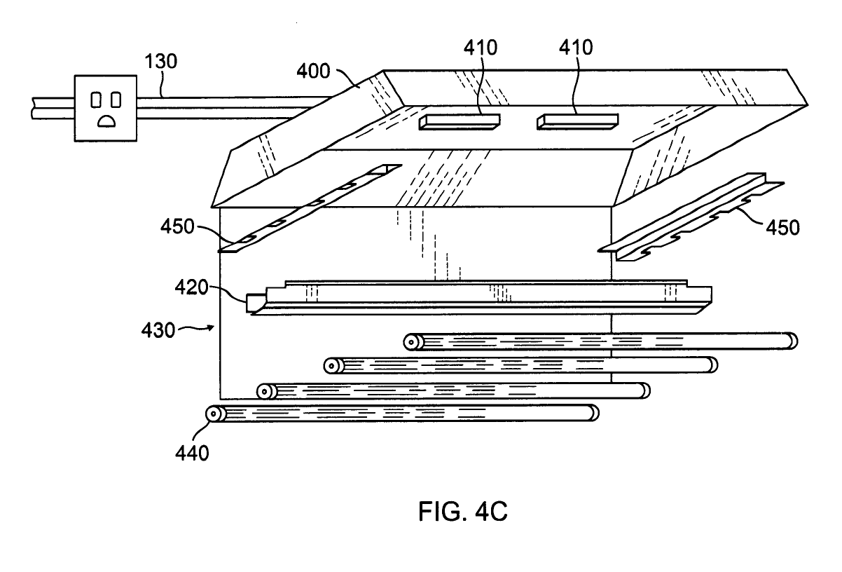

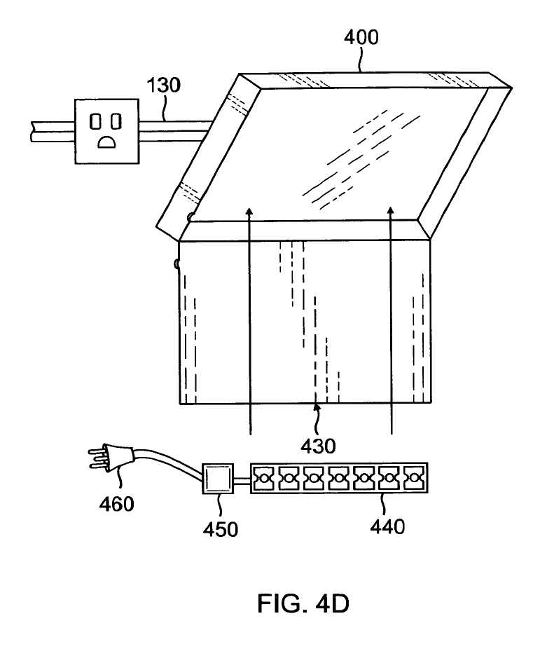

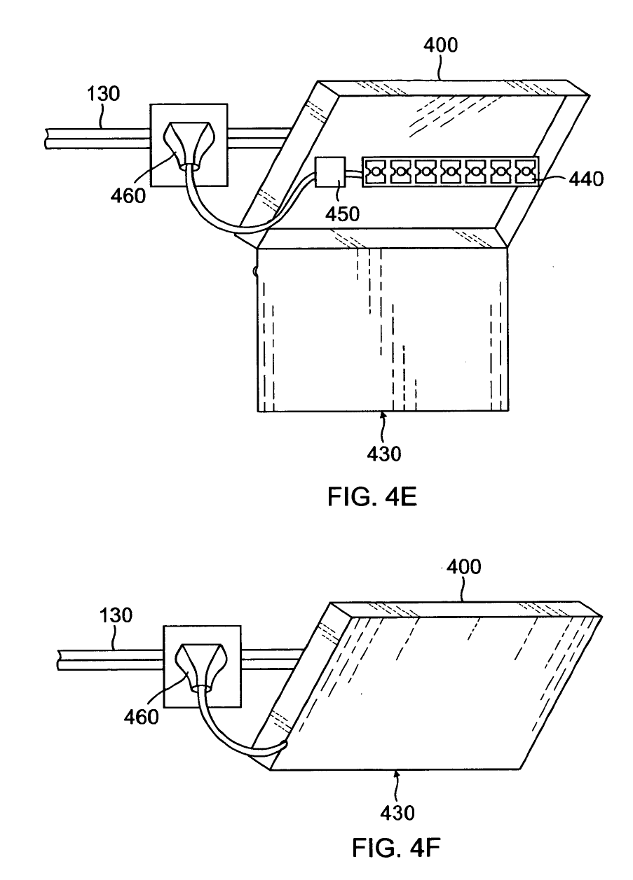

FIGS. 4A through 4F shows a perspective view of a method of retrofitting a lighting fixture according to certain embodiments of the present invention. FIG. 4A shows a lighting fixture 400 including a lens 430 coupled to a network including a power line 130 (that includes an electric socket). FIG. 4B shows a lighting fixture including a lens 430 and a light source (410, 420, 440 and 450; 440 and 450 shown in FIG. 4C), the light source including a ballast 410 and a ballast cover 420 coupled to a network including a power line 130 (that includes an electric socket) and lights 440 and socket covers (which in FIG. 4B are covered by ballast cover 420). FIG. 4C shows a lighting fixture 400 including a lens 430 and a light source (410, 420, 440 and 450) coupled to a network including a power line 130. The light source including a ballast 410 and a ballast cover 420 in which the light source including a ballast 410 and a ballast cover 420 disengaged from the lighting fixture (that includes an electric socket). FIG. 4D shows a lighting fixture 400 including a lens 430 coupled to a network including a power line 130 (that includes an electric socket), the lighting fixture being coupled to a retrofit apparatus 440 comprising a first light source including at least one LED and being configured to communicate with a second light source over a network including at least one power line 130, wherein the first light source is coupled to a controller 450 configured to communicate with the first and second light sources over the network to control the intensity and color of light emitted from the first and second light sources, wherein the controller 450 is coupled to an attachment 460 configured to connect to a network including a power line 130. FIG. 4E shows a lighting fixture 400 including a lens 430 coupled to both a network including a power line 130 and a retrofit apparatus 440 comprising a first light source including at least one LED and being configured to communicate with a second light source over a network including at least one power line 130, wherein the first light source is coupled to a controller 450 configured to communicate with the first and second light sources over the network to control the intensity and color of light emitted by the first and second light sources, wherein the controller 450 is coupled to an attachment 460 configured to connect to a network including a power line 130. In certain embodiments of the claimed invention, the lens 430 is replaced with polycarbonate lens such as one made from a dual-wall polycarbonate material. FIG. 4F shows a lighting fixture 400 including a lens 430 coupled to both a network including a power line 130 and a retrofit apparatus comprising a first light source including at least one LED and being configured to communicate with a second light source over a network including at least one power line 130, wherein the first light source is coupled to a controller configured to communicate with the first and second light sources over the network to control the intensity and color of light emitted by the first and second light sources, wherein the controller is coupled to an attachment 460 configured to connect to a network including a power line 130.

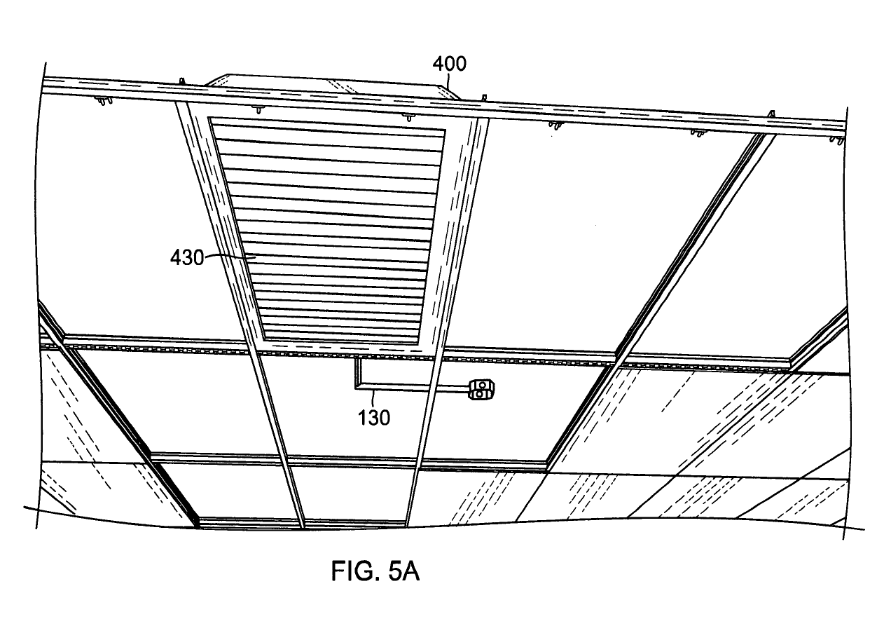

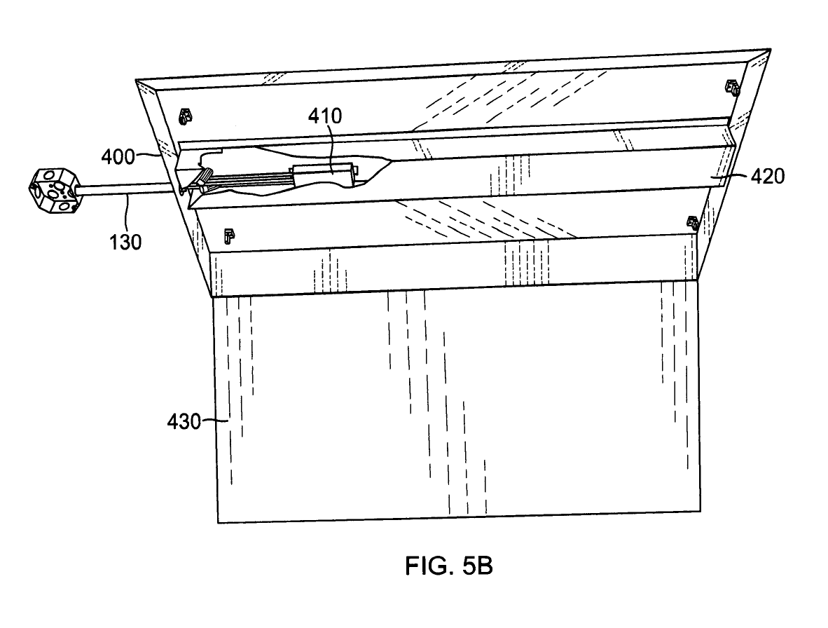

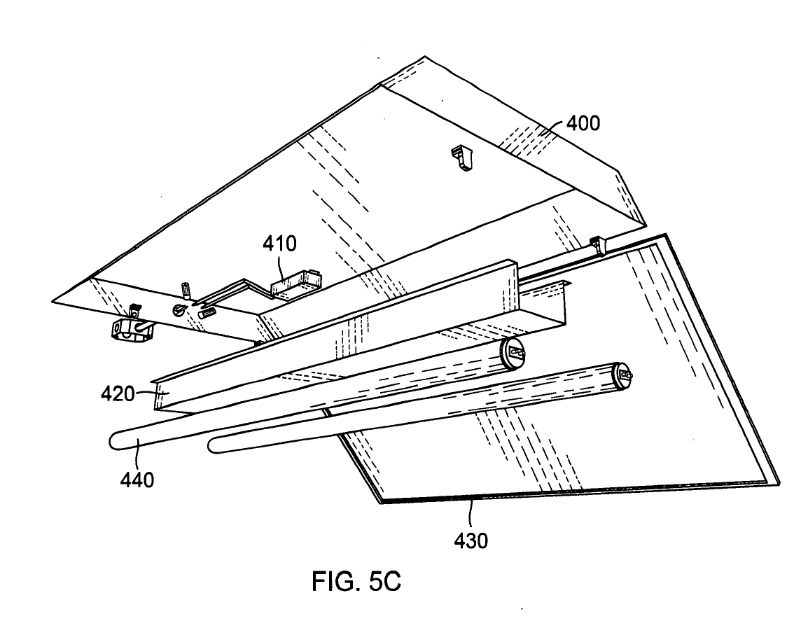

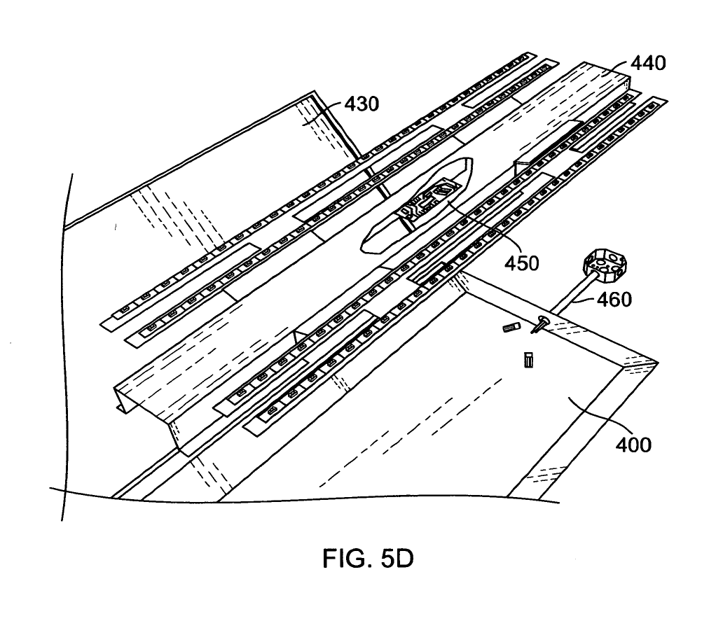

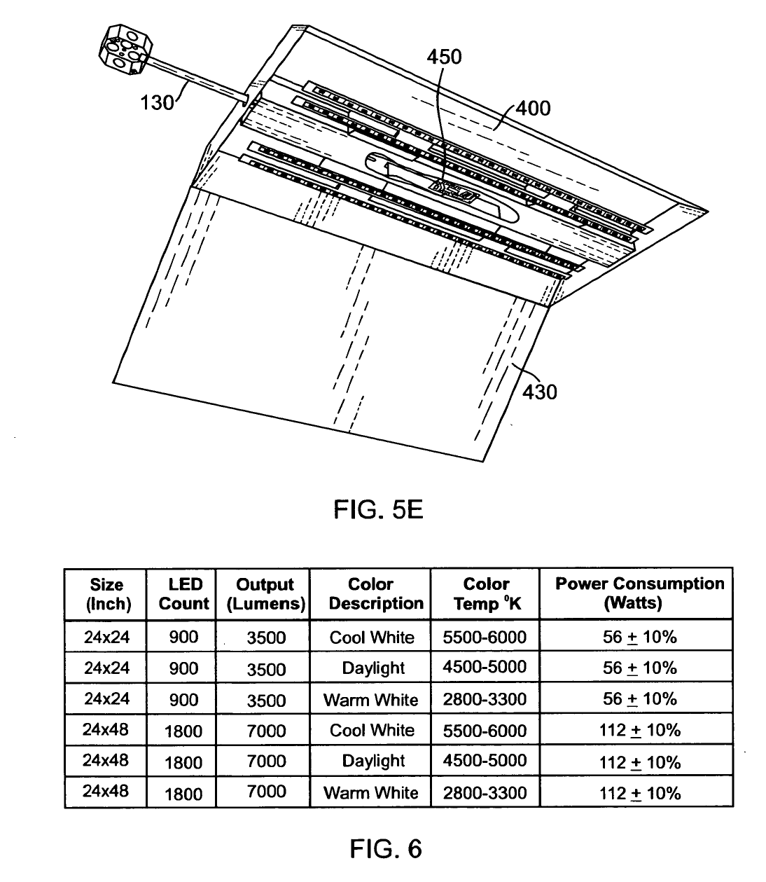

FIGS. 5A through 5E shows a perspective view of a method of retrofitting a lighting fixture according to certain embodiments of the present invention. FIG. 5A shows a lighting fixture 400 including a lens 430 coupled to a network including a power line 130. FIG. 5B shows a lighting fixture 400 including a lens 430 and a light source (410, 420 and 430; 430 is not visible), the light source including a ballast 410, a ballast cover 420 and lights 430 (not visible because they are covered by ballast cover 420) coupled to a network including a power line 130. FIG. 5C shows a lighting fixture 400 including a lens 430 and a light source (410, 420 and 440) coupled to a network including a power line 130. The light source includes a ballast 410, a ballast cover 420 and lights 440 is removed from the lighting fixture. FIG. 5D shows a lighting fixture 400 including a lens 430 coupled to a network including a power line 130, the lighting fixture being attached to a retrofit apparatus 440 comprising a first light source including at least one LED and being configured to communicate with a second light source over a network including at least one power line 130, wherein the first light source is coupled to a controller 450 configured to communicate with the first and second light sources over the network to control the intensity and color of light emitted from the first and second light sources, wherein the controller 450 is coupled to an attachment 460 configured to connect to a network including a power line 130. FIG. 5E shows a lighting fixture 400 including a lens 430 coupled to both a network including a power line 130 and a retrofit apparatus 440 comprising a first light source including at least one LED and being configured to communicate with a second light source over a network including at least one power line 130, wherein the first light source is coupled to a controller 450 configured to communicate with the first and second light sources over the network to control the intensity and color of light emitted by the first and second light sources, wherein the controller 450 is coupled to an attachment 460 configured to connect to a network including a power line 130. In certain embodiments of the claimed invention, the lens 430 is replaced with polycarbonate lens such as one made from a dual-wall polycarbonate material.

In certain embodiments of the present invention, a method of retrofitting a lighting fixture including a door or lens includes the steps of: (1) opening the door or lens; (2) removing the lights located within the lighting fixture; (3) removing the ballast cover; (4) removing the wire nuts; (5) installing a power supply retrofit kit using the removed wire nuts; (6) snapping the retrofit kit into tabs used by the ballast; and (7) either closing the door or lens or removing it. In certain embodiments of the present invention, after removing the ballast cover the ballast and or sockets can be removed.

FIG. 6 is a table depicting for certain embodiments of the present invention, various light sources' sizes, LED count, light intensity output, color description, color temperature and power consumption. Size refers to the dimensions in inches of the display portion of the light source. LED count is the number of LEDs included in the light source. Output is the intensity of the light measured in lumens produced by the light source. Color description provides a short description of the color or colors produced by the light source. Color temperature is a measure of the temperature in degree Kelvin of the light produced by the light source. Power consumption is a measure in Wafts of the power consumed by the light source. In some embodiments of the present invention, the light source can be a single source or a combination of more than one source.

It should be understood, of course, that the foregoing relates to exemplary embodiments of the invention and that modifications may be made without departing from the spirit and scope of the invention as set forth in the following claims.

What is claimed is:

1. A method for retrofitting a lighting fixture, the lighting fixture comprising prior to the retrofitting a housing and a light source located substantially within the housing, the method comprising the steps of:
removing the light source from the housing; and
attaching to the housing a retrofit apparatus comprising a first light source including at least one LED and being configured to communicate with a second light source over a network including at least one power line, wherein the first light source is coupled to a controller configured to communicate with the first and second light sources over the network to control the intensity and color of light emitted by the first and second light sources.

2. The method of claim 1, further comprising the steps of:
attaching to the housing a lens or diffuser comprising a polycarbonate material.

3. The method of claim 2, wherein the polycarbonate lens comprises a dual-wall polycarbonate material.

4. The method of claim 1, wherein the controller is operative to nonlinearly change at least one of an intensity and a color emitted by the first and second light sources.

5. The method of claim 1, wherein the controller comprises an attachment configured to connect to a network including a power line.

6. The method of claim 5, wherein the attachment configured to connect to a network including a power line comprises an electric plug.

7. The method of claim 1, wherein the network further comprises at least one radio frequency protocol.

8. The method of claim 7, wherein the first light source further comprises a remote control unit configured to communicate over the network with the second light source and the controller.

9. The method of claim 1, wherein the controller comprises an intensity controller operative to control the intensity of light emitted by the first light source and a color controller operative to control the color of light emitted by the first light source.

10. The method of claim 1, wherein the first light source further comprising a motion detector whereby the intensity and color of light emitted by the first light source is influenced by the motion detector.

11. A method for retrofitting a luminaire, the luminaire comprising a housing comprising at least one of a diffuser and a lens wherein the at least one of a diffuser and a lens is attached to the housing, and within the housing is at least one incandescent, fluorescent and halogen light, the method comprising the steps of:
substantially removing any of the at least one of a diffuser and a lens;
removing from within the housing the at least one incandescent, fluorescent or halogen light source; and
mounting within the housing a retrofit apparatus comprising a direct current (DC) power supply electrically coupled to a first light source including at least one LED, wherein the first light source is configured to communicate with a second light source over a network including at least one power line and the first light source is coupled to a controller configured to communicate with the first and second light sources over the network to control the intensity and color of light emitted by the first and second light sources.

12. The method of claim 11, further comprising the step of replacing any of the of the at least one of a diffuser and a lens.

13. The method of claim 11, further comprising the step attaching to the housing at least one of a lens and a diffuser, wherein the at least one of a lens and a diffuser comprising a polycarbonate material.

14. The method of claim 11, wherein the network comprises at least one of the X-10 protocol and the Insteon protocol.

15. The method of claim 12, further comprising the step of: coupling the network to a remote control unit configured to communicate over the network with the second light source and the controller.

16. The method of claim 12, wherein the DC power supply is configured to receive alternating current from at least one power line and to supply 12 or 24 volts to the retrofit apparatus.

17. An apparatus for retrofitting a lighting fixture comprising:
a light retrofitting means including at least one LED and an attachment configured to couple the light retrofitting means to a network including a power line; and
a controlling means configured to influence the intensity and color of light emitted by the lighting means.

18. The retrofit apparatus of claim 17, further comprising a detecting means to detect at least one of motion and sound.

19. The retrofit apparatus of claim 17, further comprising: a lens or diffuser comprising a polycarbonate material.

20. The retrofit apparatus of claim 17, wherein the controlling means comprises a remote controlling means.
